(19) United States
(12) Patent Application Publication
(10) Pub. No.: US 2008/0166624 A1
(43) Pub. Date: Jul. 10, 2008

(54) Li-ion battery pack and method of outputting DC power supply from the Li-ion battery pack to a power hand tool

(75) Inventors: Cheng-I Teng, Taichung County (TW); Hsiang-Po Huang, Taichung County (TW); Huei-Jiun Chen, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/649,908

(22) Filed: Jan. 5, 2007

(51) Int. Cl. H01M 2/20; H01M 10/36

(52) U.S. Cl. 429/50; 429/121

(57) ABSTRACT

A Li-ion battery pack includes a Li-ion battery, a protection circuit, and multiple plugs connectable to a power hand tool. The positive pole of the Li-ion battery and the DC supply terminal of the protection circuit are electrically connected to two contact pieces of one respective plug. The two contact pieces are short-circuited by the positive contact terminal of the power hand tool. The negative contact terminal of the power hand tool is connected to a negative-pole contact piece of one plug, so that when the potential difference between the positive and negative poles of the Li-ion battery surpasses the low voltage level defined by the protection circuit, the protection circuit switches on the connection between the negative pole of the Li-ion battery and the negative-pole contact piece for enabling the positive and negative contact terminals of the power hand tool to obtain DC power supply from the Li-ion battery.

### BACKGROUND OF THE INVENTION

1. Field of the Invention

The present invention relates to Li-ion battery packs and more particularly, to such a Li-ion battery pack that can be installed in a power hand tool that has only a positive contact terminal and a negative contact terminal for power input. The present invention also relates to the method of outputting DC power supply from the lithium-ion battery to the power hand tool connected to the battery.

2. Description of the Related Art

At early stage, a regular portable power hand tool uses a nickel-cadmium battery to provide the necessary working voltage. However, due to the limitation of the material characteristics, nickel-cadmium cells have only a nominal cell potential of 1.2V. Further, self-discharging reaction lowers the utilization rate of nickel-cadmium batteries. During output of DC power supply, internal cells of a nickel-cadmium battery charge each other, thereby affecting stability of output power. When a nickel-cadmium battery is not in use for a long period, the internal electrolyte solution may be oxidized and crystallized to cause dendritic shorting. In addition, incomplete discharging or overcharging will result in lowering of the internal oxidation-reduction reaction that causes the so-called memory effect. When memory effect occurs, the discharging time and the working life of the battery will be shortened.

To eliminate the aforesaid drawbacks, Li-ion battery is developed. The energy density per unit of a Li-ion battery is about 50% higher than an equivalent nickel-cadmium battery. Li-ion cells have a nominal cell potential of 4V. Li-ion batteries are currently one of the most popular types of battery for portable electronics, with one of the best energy-to-weight ratios, no memory effect and slow loss of charge when not in use. However, the structural design of a Li-ion battery is unlike a nickel-cadmium battery. A Li-ion battery has a protective circuit chip that maintains normal charging and discharging voltage and working temperature of the battery. When using a Li-ion battery in a power hand tool, the power hand tool must match the functioning of the protective circuit chip of the Li-ion battery. FIGS. 7-9 show a Li-ion battery 1 for use in a power hand tool. As illustrated, the Li-ion battery 1 comprises positive terminal 11 and a negative terminal 12 for discharge of battery power, signal input terminals 13 and 14, and a temperature detection terminal 15. However, a nickel-cadmium battery for use in a power hand tool has only a positive terminal and a negative terminal for charging and discharging. FIG. 10 shows a rechargeable nickel-cadmium battery 2′ installed in a battery holder 20 at the bottom side of a power hand tool 2. As illustrated in FIG. 11, the battery holder 20 has two contact terminals 21 and 22 for the connection of the positive pole and negative pole of the nickel-cadmium battery 2′ to obtain the necessary DC working voltage. The external structure and internal circuit functioning of the battery holder of this design of power hand tool are not compatible to the aforesaid Li-ion battery 1.

Therefore, when the user wishes to use a Li-ion battery for the aforesaid power hand tool, the battery holder of the power hand tool must be re-constructed. It is quite expensive to change the structure of the battery holder of the power hand tool for fitting a Li-ion battery.

### SUMMARY OF THE INVENTION

The present invention has been accomplished under the circumstances in view. It is one objective of the present invention to provide a lithium-ion battery pack and method of outputting DC power supply from the lithium-ion battery pack to a power hand tool, which allows direct installation of a lithium-ion battery in a power hand tool to provide DC power supply to the power hand tool without change of the body of the power hand tool that is compatible of using the conventional nickel-cadmium battery.

To achieve this objective of the present invention, the lithium-ion battery pack of the present invention comprises a battery box and a conductive contact holder mounted on the battery box. The battery box comprises a lithium-ion battery and a protection circuit. The lithium-ion battery has a positive pole and a negative pole, and a capacitance at a specific voltage level between the positive pole and the negative pole. The protection circuit has a switching terminal set, a high-level terminal set, and a low-level terminal set. The low-level terminal set is electrically connected to the negative pole of the lithium-ion battery. The conductive contact holder comprises a first plug, a second plug, and a third plug. The first plug comprises a positive-pole contact piece and a signal contact piece respectively electrically connected to the positive pole of the lithium-ion battery and the high-level terminal set of the protection circuit. The second plug comprises a charging contact piece electrically connected to the negative pole of the lithium-ion battery. The third plug comprises a negative-pole contact piece electrically connected to the switching terminal set of the protection circuit. When the lithium-ion battery pack is attached to a power hand tool, the positive contact terminal for DC power input of the power hand tool is connected to the signal contact piece and the positive-pole contact piece of the first plug, therefore the positive contact terminal of the power hand tool is electrically connected to the positive pole of the lithium-ion battery, and the positive-pole contact piece and the signal contact piece are short-circuited. At the same time, the negative contact terminal of the power hand tool is connected to the negative-pole contact piece of the third plug, so that the negative contact terminal of the power hand tool is electrically connected to the switching terminal set of the protection circuit.

The present invention also provides a method of outputting DC power supply from the aforesaid lithium-ion battery to the power hand tool having the positive contact terminal and the negative contact terminal for DC power input. The method comprises the steps of a) connecting the positive contact terminal of the power hand tool to the positive-pole contact piece and the signal contact piece of the first plug of the lithium-ion battery pack such that the positive contact terminal of the power hand tool is electrically connected to the positive pole of the lithium-ion battery of the lithium-ion battery pack and the positive-pole contact piece and the signal contact piece of the first plug of the lithium-ion battery pack are short-circuited with each other, b) connecting the negative contact terminal of the power hand tool to the negative-pole contact piece of the third plug of the lithium-ion battery pack, and c) electrically connecting the negative contact terminal of the power hand tool to the negative pole of the lithium-ion battery by means of the enablement of the electrical connection of the switching terminal set of the protection circuit to the low-level terminal set of the protection circuit when a potential difference between the positive pole and the negative pole of the lithium-ion battery surpasses a predetermined voltage level, such that the positive contact terminal and the negative contact terminal of the power hand tool obtains DC power supply from the positive pole and the negative pole of the lithium-ion battery.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a lithium-ion battery pack in accordance with a preferred embodiment of the present invention;

FIG. 2 is a schematic drawing showing the circuit arrangement of the lithium-ion battery pack according to the preferred embodiment of the present invention;

FIG. 3 is a side view showing that a power hand tool is connected to the lithium-ion battery pack according to the preferred embodiment of the present invention;

FIG. 4 is a sectional view taken along line 4-4 of FIG. 3;

FIG. 5 is a sectional view taken along line 5-5 of FIG. 3;

FIG. 6 is an enlarged view of a part of FIG. 5;

FIG. 7 is a top view of a conventional lithium-ion battery;

FIG. 8 is a front view of the lithium-ion battery shown in FIG. 7;

FIG. 9 is a rear side view of the lithium-ion battery shown in FIG. 7;

FIG. 10 shows the conventional nickel-cadmium battery connected with a power hand tool, and FIG. 11 is a schematic view of the battery holder of a conventional power hand tool.

### DETAILED DESCRIPTION OF THE INVENTION

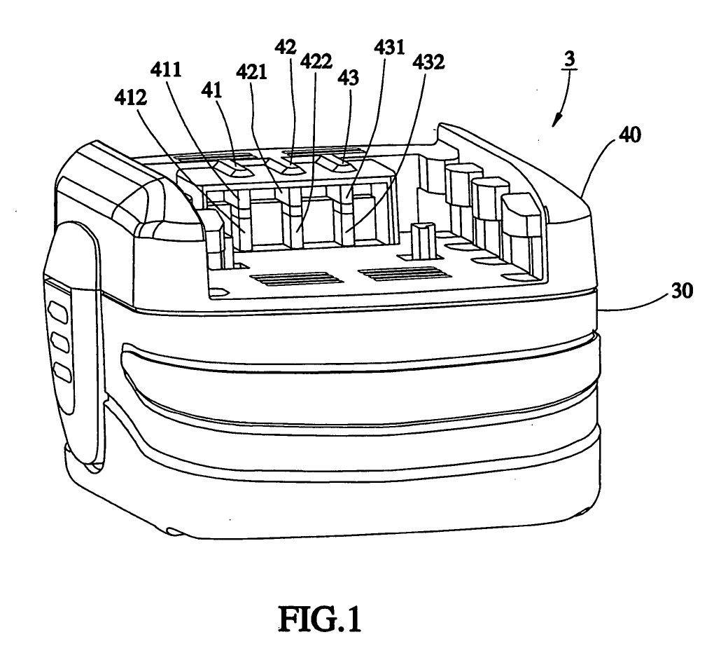

As shown in FIG. 1, a lithium-ion battery pack 3 adapted to output DC power supply at a specific voltage level to a hand tool connected thereto comprises a battery box 30 and a conductive contact holder 40 connected to the battery box 30.

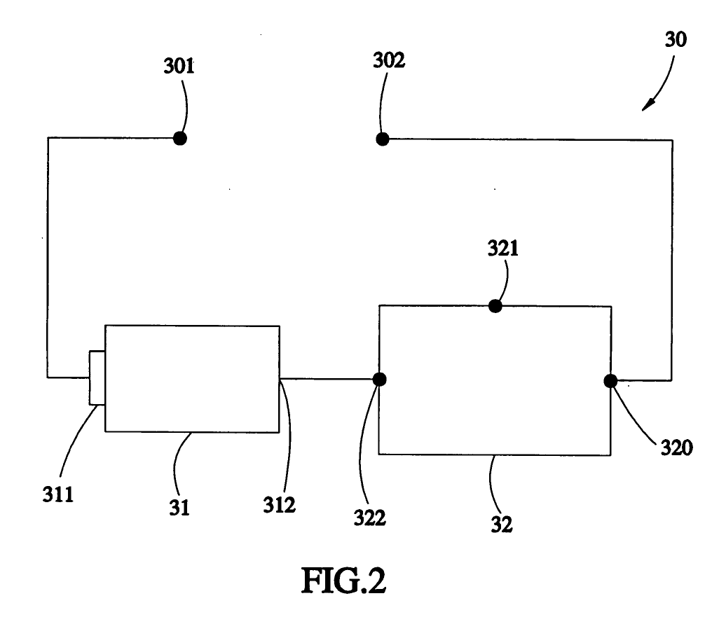

As shown in FIG. 2, the battery box 30 holds therein a lithium-ion battery 31 and a protection circuit 32. The lithium-ion battery 31 comprises a number of cells. By means of an electrochemical reaction, the lithium-ion battery 31 is rechargeable to obtain and provide electric potential energy. The lithium-ion battery 31 has a positive pole 311 at one end and a negative pole 312 at the other end. The cells of the lithium-ion battery 31 between the positive pole 311 and the negative pole 312 provide an equivalent voltage. Therefore, the lithium-ion battery 31 is capable of output DC power supply at the aforesaid specific voltage level. The positive pole 311 of the lithium-ion battery 31 is electrically connected to a positive output terminal 301. The protection circuit 32 is designed subject to charging and discharging characteristics of the cells of the lithium-ion battery 31 to avoid an excessively high charging voltage or an excessively low discharging voltage, thereby protecting working of the lithium-ion battery 31 within the normal operating range and stabilizing the circuit that is electrically connected to the lithium-ion battery 31. The protection circuit 32 comprises a switching terminal set 320, a high-level terminal set 321, and a low-level terminal set 322. The switching terminal set 320 is electrically connected to a negative output terminal 302 for allowing the internal chip of the protection circuit 32 to switch on/off the connection between the low-level terminal set 322 and the negative output terminal 302. The low potential terminal set 322 is electrically connected to the negative pole 312 of the lithium-ion battery 31. The high-level terminal set 321 and the low-level terminal set 322 respectively obtain a potential from the positive pole 311 and negative pole 312 of the lithium-ion battery 31, and therefore DC driving power is inputted to drive the protection circuit 32.

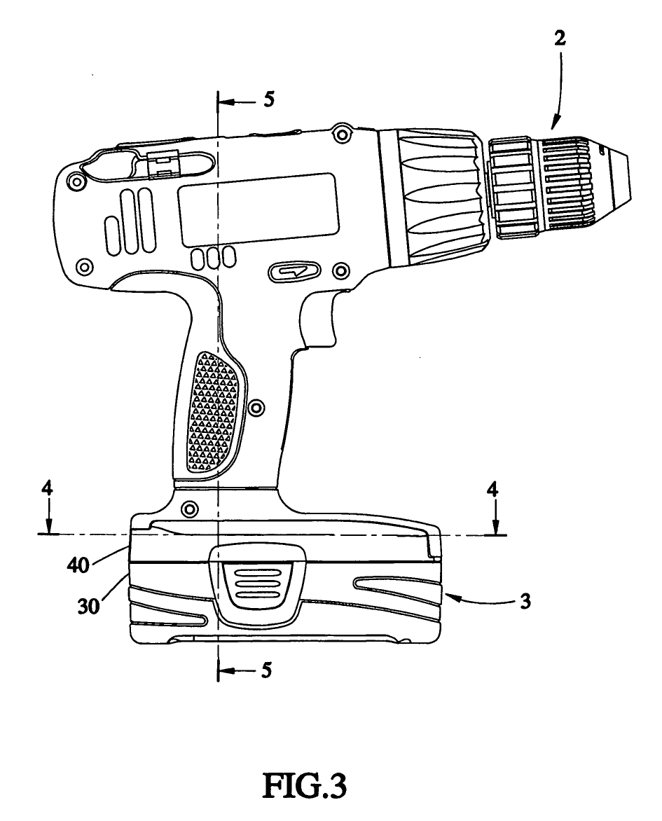

Referring to FIG. 3 and FIG. 1 again, the conductive contact holder 40 is provided at the top side of the battery box 30 for receiving a power hand tool 2 that can use a nickel-cadmium battery to provide the necessary working voltage. The conductive contact holder 40 comprises a first plug 41, a second plug 42, and a third plug 43. The plugs 41-43 are arranged in parallel and spaced from one another at a predetermined pitch, each having two electrically isolated metal contact pieces. The first plug 41 comprises a signal contact piece 411 and a positive-pole contact piece 412. The second plug 42 comprises a charging contact piece 421 and a temperature-control contact piece 422. The third plug 43 comprises a negative-pole contact piece 431 and a recognition contact piece 432. The signal contact piece 411 is electrically connected to the high-level terminal set 321 of the protection circuit 32. The positive-pole contact piece 412 is electrically connected to the positive pole 311 of the lithium-ion battery 31 through the positive output terminal 301 in the battery box 30. The charging contact piece 421 is electrically connected to the negative pole 312 of the lithium-ion battery 31. The temperature-control contact piece 422 is electrically connected to the temperature sensor of the lithium-ion battery 31 to detect the operating temperature of the lithium-ion battery 31. The negative-pole contact piece 431 is electrically connected to the switching terminal set 320 of the protection circuit 32 through the negative output terminal 302 in the battery box 30. The recognition contact piece 432 is electrically connected to the protection circuit 32 to obtain a potential provided by the lithium-ion battery 31 so that when the lithium-ion battery pack 3 is electrically connected to a battery charger, the recognition contact piece 432 provides an induction potential for enabling the battery charger to recognize the lithium-ion battery 31.

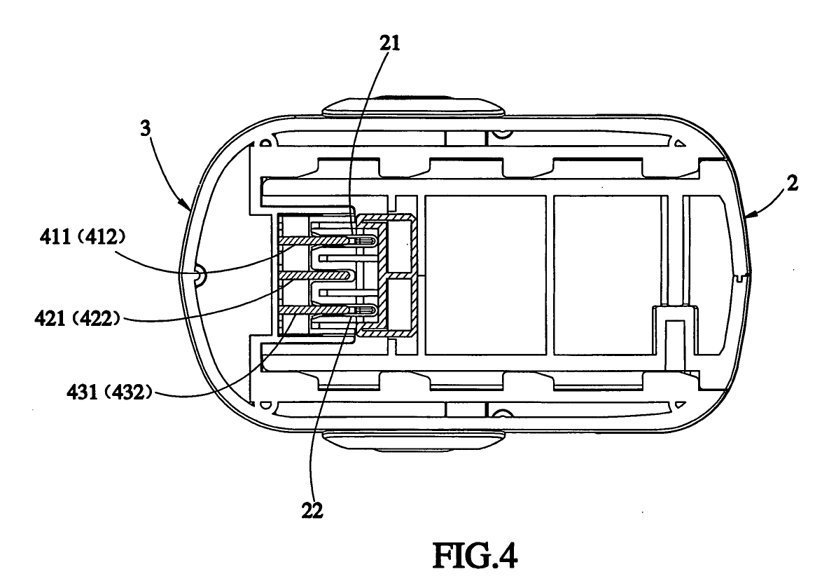

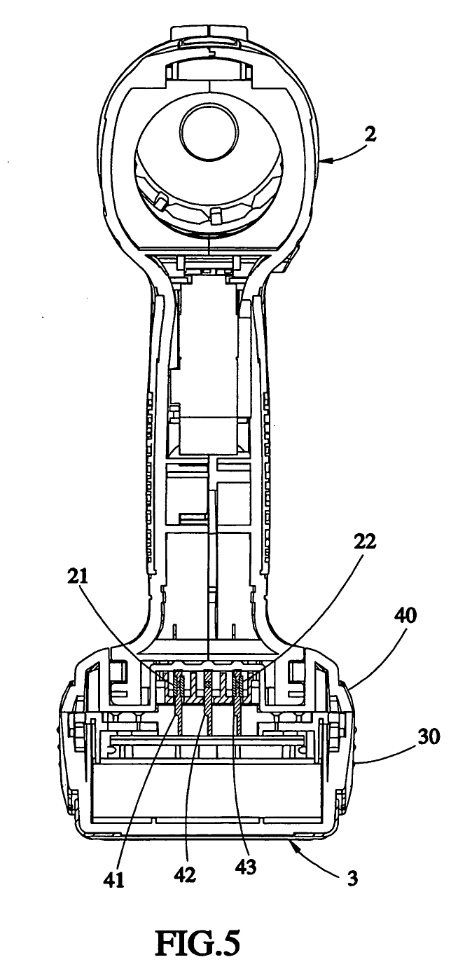

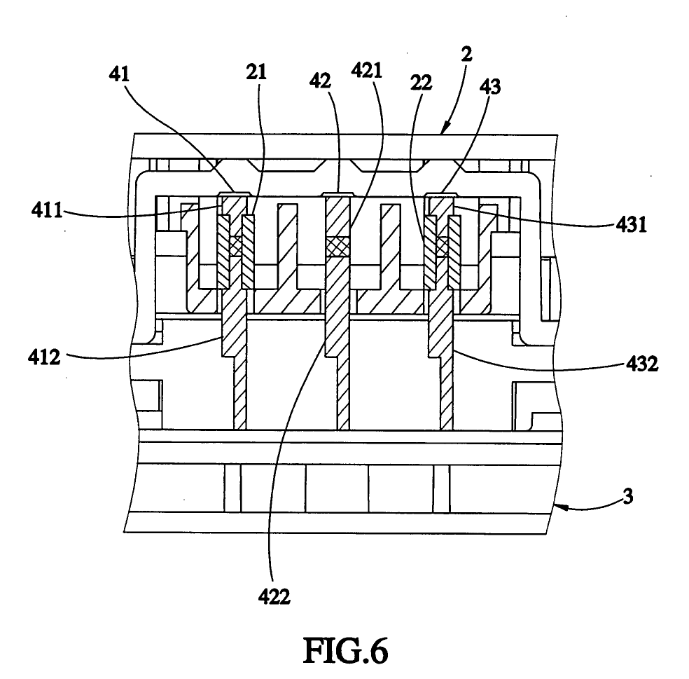

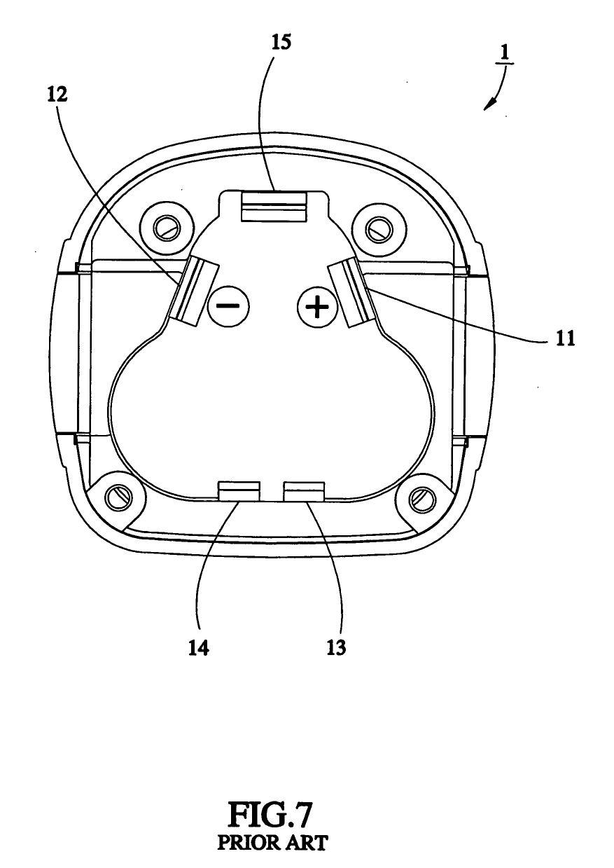

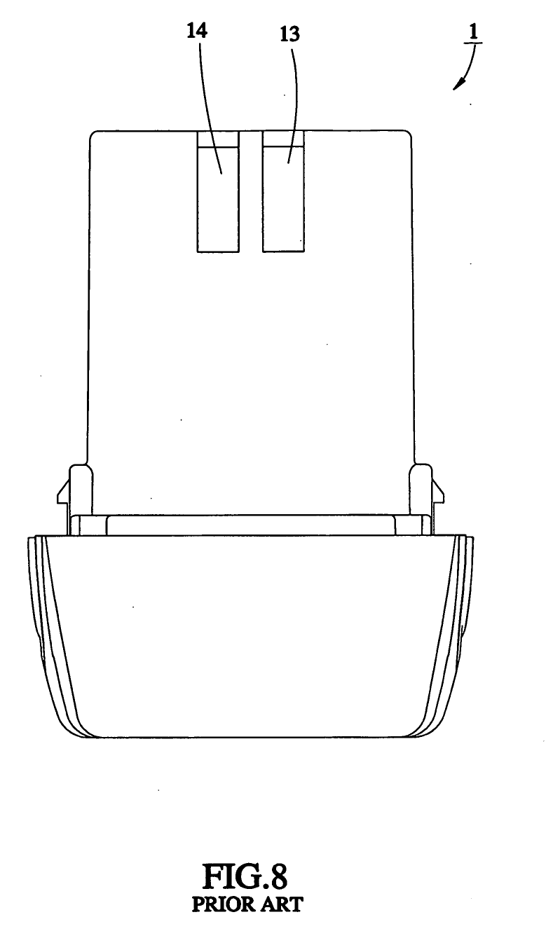

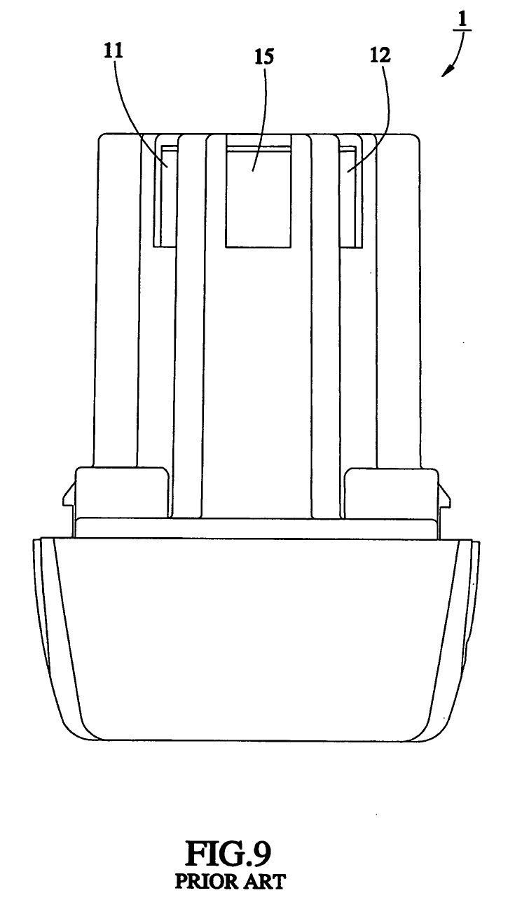

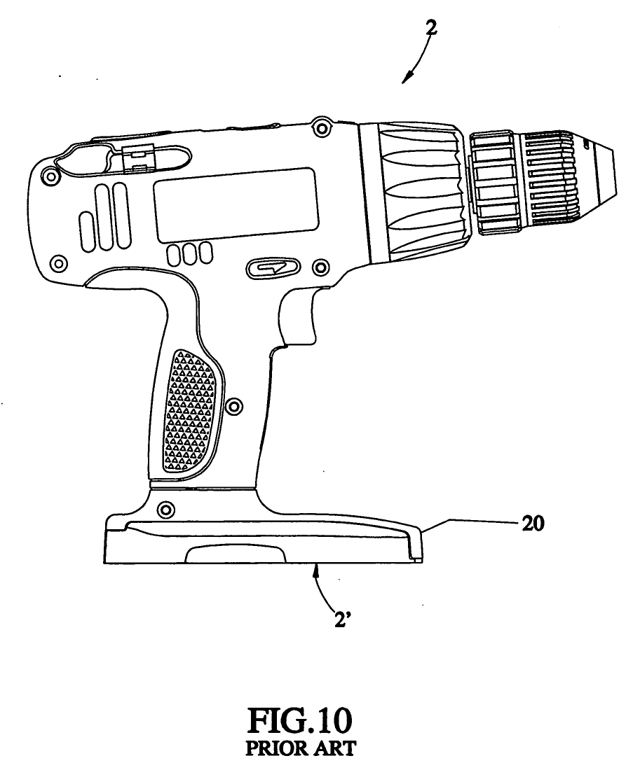

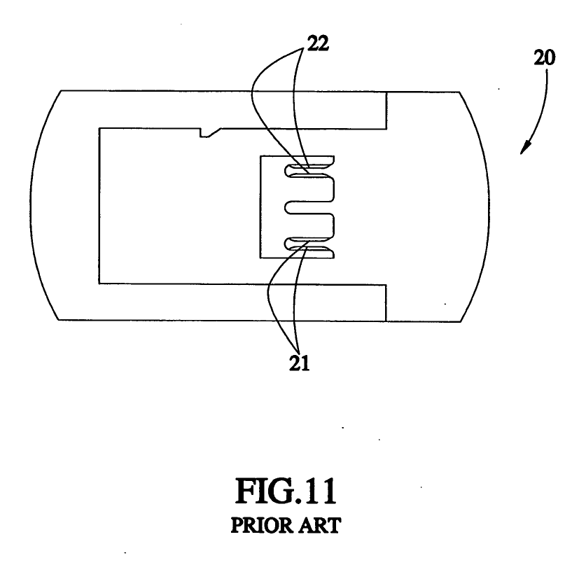

FIGS. 4-6 show the respective connection interfaces of the lithium-ion battery pack 3 and the power hand tool 2 in actual application. The positive contact terminal 21 of the power hand tool 2 is connected to the signal contact piece 411 and positive-pole contact piece 412 of the first plug 41 so that the positive contact terminal 21 is electrically connected to the positive pole 311 of the lithium-ion battery 31 and the signal contact piece 411 and the positive-pole contact piece 412 are short-circuited with each other by the positive contact terminal 21. The negative contact terminal 22 of the power hand tool 2 is connected to the negative-pole contact piece 431 of the third plug 43 so that the negative contact terminal 22 is electrically connected to the switching terminal set 320 of the protection circuit 32. The operation of the lithium-ion battery pack 3 is described hereinafter.

Because the high-level terminal set 321 and low-level terminal set 322 of the protection circuit 32 respectively obtain a potential from the positive pole 311 and negative pole 312 of the lithium-ion battery 31, the protection circuit 32 is driven on. When started, the protection circuit 32 determines the potential difference between the positive pole 311 and the negative pole 312.

When the lithium-ion battery 31 is well charged such that the potential difference between the positive pole 311 and the negative pole 312 surpasses the low voltage level defined by the protection circuit 32, the switching circuit of the internal chip of the protection circuit 32 switches to enable the connection between the low-level terminal set 322 and the switching terminal set 320 to have the negative contact terminal 22 of the power hand tool 2 be electrically connected to the negative pole 312 of the lithium-ion battery 31, and therefore the positive contact terminal 21 and negative contact terminal 22 of the power hand tool 2 obtain DC power supply from the potential difference between the positive pole 311 and the negative pole 312 of the lithium-ion battery 31.

When the potential difference between the positive pole 311 and the negative pole 312 dropped below the low voltage level defined by the protection circuit 32 after a period of use of the lithium-ion battery 31, the switching circuit of the internal chip of the protection circuit 32 switches off the connection between the low-level terminal set 322 and the switching terminal set 320 to interrupt the internal electric current loop of the battery box 30, thereby stopping the lithium-ion battery 31 from outputting DC power supply to the power hand tool 2.

The lithium-ion battery pack of the present invention is adapted for connection to a power hand tool having a positive contact terminal and a negative contact terminal for power input. The conductive contact holder 40 of the lithium-ion battery pack 3 is not limited to the arrangement of the contact pieces of the aforesaid plugs 41-43, i.e., the invention allows output of battery power supply through the five contact terminals of the lithium-ion battery pack to the positive contact terminal and negative contact terminal of a power hand tool.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lithium-ion battery pack for outputting DC power supply at a specific voltage level, the lithium-ion battery pack comprising:
a battery box including a lithium-ion battery having a positive pole and a negative pole and a capacitance at the specific voltage level between the positive pole and the negative pole, and a protection circuit having a switching terminal set, a high-level terminal set, and a low-level terminal set electrically connected to the negative pole of the lithium-ion battery; and
a conductive contact holder mounted on the battery box and provided with a first plug with a positive-pole contact piece and a signal contact piece respectively electrically connected to the positive pole of the lithium-ion battery and the high-level terminal set of the protection circuit, a second plug with a charging contact piece electrically connected to the negative pole of the lithium-ion battery, and a third plug with a negative-pole contact piece electrically connected to the switching terminal set of the protection circuit.

2. The lithium-ion battery pack as claimed in claim 1, wherein the positive-pole contact piece and the signal contact piece of the first plug are kept apart by a predetermined pitch.

3. The lithium-ion battery pack as claimed in claim 1, wherein the first plug, the second plug and the third plug have substantially a same size.

4. The lithium-ion battery pack as claimed in claim 1, wherein the second plug is spacedly located between the first plug and the second plug.

5. The lithium-ion battery pack as claimed in claim 1, wherein the second plug further comprises a temperature control contact piece for detecting the operating temperature of the lithium-ion battery.

6. The lithium-ion battery pack as claimed in claim 1, wherein the third plug further comprises a recognition contact piece electrically connected to the lithium-ion battery through the protection circuit.

7. A method of outputting DC power supply from the lithium-ion battery of claim 1 to a power hand tool having a positive contact terminal and a negative contact terminal for DC power input, the method comprising the steps of:
(a) connecting the positive contact terminal of the power hand tool to the positive-pole contact piece and the signal contact piece of the first plug of the lithium-ion battery pack such that the positive contact terminal of the power hand tool is electrically connected to the positive pole of the lithium-ion battery of the lithium-ion battery pack and the positive-pole contact piece and the signal contact piece of the first plug of the lithium-ion battery pack are short-circuited with each other;
(b) connecting the negative contact terminal of the power hand tool to the negative-pole contact piece of the third plug of the lithium-ion battery pack; and
(c) electrically connecting the negative contact terminal of the power hand tool to the negative pole of the lithium-ion battery by means of the enablement of the electrical connection of the switching terminal set of the protection circuit to the low-level terminal set of the protection circuit when a potential difference between the positive pole and the negative pole of the lithium-ion battery surpasses a predetermined voltage level, such that the positive contact terminal and the negative contact terminal of the power hand tool obtains DC power supply from the positive pole and the negative pole of the lithium-ion battery.

8. The method as claimed in claim 7, further comprising the step of driving on the protection circuit to determine the potential difference between the positive pole and the negative pole of the lithium-ion battery when the high-level terminal set and the low-level terminal set of the protection circuit of the battery box respectively obtain a potential from the positive pole and the negative pole of the lithium-ion battery.

9. The method as claimed in claim 7, further comprising the step of electrically disconnecting the negative contact terminal of the power hand tool from the negative pole of the lithium-ion battery when the potential difference between the positive pole and the negative pole of the lithium-ion battery drops below the predetermined voltage level.

10. The method as claimed in claim 9, further comprising the step of switching off the connection between the low-level terminal set and the switching terminal set of the protection circuit when the potential difference between the positive pole and the negative pole of the lithium-ion battery drops to the predetermined voltage level.
